(19) United States
(12) Patent Application Publication
(10) Pub. No.: US 2022/0371216 A1
(43) Pub. Date: Nov. 24, 2022

(54) AUTOMATICALLY ADJUSTABLE SYSTEM FOR CUTTING AT VARIABLE NOTCH ANGLES

(71) Applicant: KONGSBERG PRECISION CUTTING SYSTEMS AS, Kongsberg (NO)

(72) Inventors: Matti Damgaard WINTHER, Skollenborg (NO); Sondre HUSTVEIT, Kongsberg (NO); Simon KVANVIK, Kongsberg (NO); Thomas MALME, Kongsberg (NO); Satish NAIDU, Kongsberg (NO); Lidvar BUDAL, Hønefoss (NO); Ivar HOLM, Hokksund (NO); Knut JOHANSEN, Kongsberg (NO)

(73) Assignee: KONGSBERG PRECISION CUTTING SYSTEMS AS, Kongsberg (NO)

(21) Appl. No.: 17/770,954

(22) PCT Filed: Oct. 13, 2020
(86) PCT No.: PCT/EP2020/078731

§ 371 Date: Apr. 21, 2022

Related U.S. Application Data
(60) Provisional application No. 62/924,881, filed on Oct. 23, 2019.

(51) Int. Cl. B26D 7/26; B26D 5/00; B26D 3/06; G05B 19/18

(52) U.S. Cl. CPC B26D 7/2628; B26D 5/005; B26D 3/06; G05B 19/182; G05B 2219/49099

(57) ABSTRACT

A knife assembly for cutting a substrate during relative motion between the knife and the substrate, the assembly including a knife having a distal knife blade and a proximal knife shaft attached to a holder rotatable about a first axis perpendicular to the substrate to define a cut direction angle. The holder is also configured to rotate the knife blade about a second axis perpendicular to the first axis to form a notch angle relative to the first axis. The notch angle is preferably automatically infinitely adjustable within a range of angles. The holder may also, optionally, be configured to rotate the knife blade about a third axis perpendicular to a plane defined by the knife blade to adjust an angle of attack of the knife blade relative to the substrate.

### CROSS REFERENCE TO RELATED APPLICATIONS

The instant application is a U.S. National Stage application of and claims priority to PCT/EP2020/078731, filed on Oct. 13, 2020, which is a PCT application of and claims priority to U.S. Provisional Application No. 62/924,881, filed on Oct. 23, 2019, the subject matter of both aforementioned applications is hereby incorporated by reference in its entirety.

### BACKGROUND OF THE INVENTION

In the process of converting thicker materials that require folding, e.g. plastic or paper fluted core boards (single, double and triple wall), such as corrugated cardboard, paper or plastic honeycomb boards, foam board, flexographic cliches, solid paper board and display boards, a special knife assembly capable of producing an angled cut in the material may be used. For example, as depicted in FIG. 1, a single wall fluted core board (e.g. corrugated cardboard) 100 comprises fluting 130 disposed between liners 110, 120. Performing a cut twice from two opposite directions just above the bottom liner 110 with an angled blade will produce a V-shaped slot 140 in the material after the cut part has been removed, also referred to as a V-notch or V-cut. Thus, by cutting two 450 lines, a 90° fold can be realized in the final product.

Commercial cutting systems, such as the Esko Kongsberg C-series systems, the details of which are incorporated by reference, are configured to cut a substrate during relative motion between the knife and the substrate. Such systems may include optional V-notch knife assemblies, each configured to cut at a specific angle (e.g. 15°, 22.5°, 30° and 45°). The foregoing knives thus permit a user to create corresponding (e.g. 30°, 45°, 60°, and 90° corners). If more than one angle is required within a job, however, the operator has to pause the production and manually change the adapter from one angle to another. Additionally, the available angles are typically predetermined, and cannot be chosen arbitrarily.

Thus, there is a need for improved cutting systems with greater flexibility for cutting angles and/or easier/faster changing from one type or angle of cut to another.

### SUMMARY OF THE INVENTION

One aspect of the invention comprises a knife assembly for cutting a substrate during relative motion between the knife and the substrate. The assembly comprises a knife having a knife blade and a proximal knife shaft attached to a knife holder. The knife holder is rotatable about a first axis perpendicular to the substrate to define a cut direction angle. The knife holder is also configured to rotate the knife blade about a second axis perpendicular to the first axis to form a notch angle relative to the first axis. The notch angle is preferably infinitely adjustable within a range of angles, such as symmetrical relative to the first axis from −60 to +60 degrees. The knife assembly is preferably adjustable in a Z direction perpendicular to the substrate. The knife holder may also optionally be configured to rotate the knife blade about a third axis perpendicular to a plane defined by the knife blade, which rotation about the third axis adjusts an angle of attack of the knife blade relative to the substrate within a desired range.

A cutting system may include the knife assembly as described herein with means for causing relative motion between the knife assembly and the substrate, and a control system for controlling a direction of the relative motion, the cut direction angle, and the notch angle. The control system may be programmable to position the distal end of the knife blade relative to a thickness of the substrate operable to fully penetrate or not fully penetrate a thickness of the substrate from a top surface to a bottom surface of the substrate, and to create zero and non-zero notch angles, including executing multiple cutting operations at a non-zero notch angle to form a V-notch in the substrate that does not fully penetrate the substrate. The control system may be configured to permit selection of a knife angle pivot point, where the second and third axes of rotation intersect, at a desired distance from the substrate top surface as a non-changing reference point for kinematics relating to the knife. The pivot point may be selectable within a range including at least a first point residing on the top surface of the substrate and at least a second point residing on the bottom surface of the substrate such that a cut line in the substrate relative to the reference point is independent of the knife notch angle.

In some embodiments, the control system may also be configured to control operation of the knife assembly based upon information in a 2D design file, including selecting the cut direction angle and the direction of relative motion of the knife assembly based upon a location of lines in a 2D design file, and selecting values for the notch angle, the angle of attack, or a combination thereof, based upon a line property in the 2D design file, such as line type, line color, or line width. One or more 2D design file line properties may be associated with custom defined angle values, and other line properties may be predefined for a plurality of commonly used values (e.g. 0°, 15°, 22.5°, 30° and 45°).

In other embodiments, the control system may be configured to control operation of the knife assembly based upon information in a 3D design file, wherein the cut direction angle, the direction of relative motion, and the notch angle are derived from a 3D cut shape as defined in the 3D design file, and the angle of attack is defined by a cut surface property as represented in the 3D design file.

In one configuration, the holder includes a worm gear assembly comprising a worm driver attached to a motor and a circumferential portion of a worm wheel. The proximal end of the knife shaft is attached to the circumferential portion of the worm wheel so that a predetermined rotation of the worm driver provides a corresponding adjustment of the notch angle.

In another configuration, a first relatively proximal connection point on the knife shaft connects to a linearly moveable portion of a first linear actuator and a second intermediate connection point, located between the first connection point and the distal end on the knife shaft, connects to a linearly moveable portion of a second linear actuator. The first and second linear actuators are coordinated to provide adjustability of the notch angle while maintaining a second vertically translatable rotation axis of the blade lying along the first axis. Each of the first and second linear actuators may comprise a linear motor, a ball screw device, or a piezoelectric device.

An aspect of the invention comprises a method for cutting a substrate. The method comprises providing a cutting system having an adjustable knife assembly comprising a knife blade having a distal knife blade and a proximal knife shaft attached to a knife holder. The knife holder is (i) rotatable about a first axis perpendicular to the substrate to define a cut direction angle, (ii) configured to rotate the knife blade about a second axis perpendicular to the first axis to form a notch angle relative to the first axis, wherein the notch angle is infinitely adjustable within a range of angles, (iii) adjustable in a Z direction perpendicular to the substrate, and (iv) optionally, configured to rotate the knife blade about a third axis perpendicular to a plane defined by the knife blade, wherein rotation about the third axis adjusts an angle of attack of the knife blade relative to the substrate within a desired range. The method comprises causing relative motion between the knife assembly and the substrate, including automatically controlling a direction of the relative motion, the cut direction angle, and the notch angle. Automatically controlling the notch angle includes automatically changing the notch angle from a first notch angle to a second notch angle using the adjustable knife assembly. The method may include a computer processor of the cutting system reading information from a design file and controlling operation of the knife assembly and relative motion between the knife assembly and the substrate based upon information in the design file.

In embodiments in which the design file is a 2D design file, the computer processor may select the cut direction angle and the direction of relative motion of the knife assembly based upon location of lines in the 2D design file, and select values for the notch angle and the angle of attack based upon a line property in the 2D design file. In embodiments in which the design file is a 3D design file, the computer processor may select the cut direction angle, the direction of relative motion, and the notch angle based upon a 3D cut shape as defined in the 3D design file and the angle of attack based upon a cut surface property represented in the 3D design file.

Still another aspect of the invention comprises a non-transitory computer-readable medium encoded with instructions embodied in a design file readable by a computer processor for controlling a control system of a cutting system. The cutting system includes an adjustable knife assembly comprising a knife having a distal knife blade and a proximal knife shaft attached to a knife holder, the knife holder (i) rotatable about a first axis perpendicular to the substrate to define a cut direction angle, (ii) configured to rotate the knife blade about a second axis perpendicular to the first axis to form a notch angle relative to the first axis, wherein the notch angle is infinitely adjustable within a range of angles, (iii) adjustable in a Z direction perpendicular to the substrate, and (iv) optionally, configured to rotate the knife blade about a third axis perpendicular to a plane defined by the knife blade, wherein rotation about the third axis adjusts an angle of attack of the knife blade relative to the substrate within a desired range. The cutting system also includes means for causing relative motion between the knife assembly and the substrate, including automatically controlling a direction of the relative motion, the cut direction angle, and the notch angle. The instructions include instructions for controlling operation of the knife assembly and relative motion between the knife assembly and the substrate based upon information in the design file, including instructions for causing the control system to change the notch angle from a first notch angle to a second notch angle automatically using the adjustable knife assembly.

In embodiments in which the design file is a 2D design file comprising instructions corresponding to a plurality of lines, each line has one or more line properties, in which at least one line property corresponds to a selected value for the notch angle, at least one line property corresponds to the angle of attack, or a combination thereof. The line property is selected from the group consisting of line type, line color, and line width. One or more line properties may be associated with custom defined angle values and a plurality of other line properties may be predefined for a plurality of commonly used values. In embodiments in which the design file is a 3D design file, the cut direction angle, the direction of relative motion, and the notch angle may be represented by a 3D cut shape as defined in the 3D design file, and the angle of attack may be defined by a cut surface property as represented in the 3D design file.

Yet another aspect of the invention comprises a method for creating a design file for being processed by a cutting system. The method comprises creating a design file embodying instructions readable by a computer processor for controlling a control system of a cutting system. The cutting system has an adjustable knife assembly comprising a knife having a distal knife blade and a proximal knife shaft attached to a knife holder, the knife holder (i) rotatable about a first axis perpendicular to the substrate to define a cut direction angle, (ii) configured to rotate the knife blade about a second axis perpendicular to the first axis to form a notch angle relative to the first axis, wherein the notch angle is infinitely adjustable within a range of angles, (iii) adjustable in a Z direction perpendicular to the substrate, and (iv) optionally, configured to rotate the knife blade about a third axis perpendicular to a plane defined by the knife blade, wherein rotation about the third axis adjusts an angle of attack of the knife blade relative to the substrate within a desired range. The cutting system further comprising means for causing relative motion between the knife assembly and the substrate, including automatically controlling a direction of the relative motion, the cut direction angle, and the notch angle. The instructions include instructions for controlling operation of the knife assembly and relative motion between the knife assembly and the substrate based upon information in the design file, including instructions for causing the control system to automatically change the notch angle from a first notch angle to a second notch angle using the adjustable knife assembly. In embodiments in which the design file is a 2D design file comprising instructions corresponding to a plurality of lines, each line may have one or more line properties, wherein at least one line property corresponds to a selected value for the notch angle, at least one line property corresponds to the angle of attack, or a combination thereof. In embodiments in which the design file is a 3D design file, the cut direction angle, the direction of relative motion, and the notch angle may be represented by a 3D cut shape as defined in the 3D design file, and the angle of attack may be defined by a cut surface property as represented in the 3D design file.

### BRIEF DESCRIPTION OF THE DRAWINGS

FIG. 1 is a cross-sectional view schematically depicting a substrate with a V-notch according to the prior art.

FIG. 2A is a perspective view schematically depicting an exemplary knife blade for cutting a substrate.

FIG. 2B is a top view schematically depicting the exemplary knife blade of FIG. 2A having an adjustable cut direction angle about axis C.

FIG. 2C is a front view schematically depicting the exemplary knife blade of FIG. 2A having an adjustable notch angle about axis A.

FIG. 2D is a side view schematically depicting the exemplary knife blade of FIG. 2A having an adjustable angle of attack about axis B.

FIG. 3A is a front view schematically depicting an exemplary mechanism for providing an automatically adjustable notch angle.

FIG. 3B is a schematic diagram of an exemplary control system for the exemplary mechanism of FIG. 3A.

FIG. 3C is a front view schematically depicting another exemplary mechanism for providing an automatically adjustable notch angle.

FIG. 4 is a front view schematically depicting another exemplary mechanism for providing an automatically adjustable notch angle.

FIG. 5 is a perspective view schematic of an exemplary cutting system.

FIG. 6 is a schematic flow chart depicting steps of an exemplary workflow using an exemplary cutting system as described herein.

FIG. 7 is a perspective schematic view of an exemplary tool mounted on a carriage.

FIG. 8 is a perspective schematic side view of the tool mounted on an exemplary Z-wagon depicted in FIG. 7, showing additional elements of the mechanical system.

FIG. 9A is a perspective schematic view of the exemplary Z-wagon of FIG. 8.

FIG. 9B is a perspective schematic view of the exemplary translation system located behind the Z-wagon of FIG. 9A.

FIG. 10A is an isolated perspective schematic view of the exemplary tool depicted in FIG. 7.

FIG. 10B is a perspective schematic view of the exemplary tool depicted in FIG. 10A, with the housing removed.

FIG. 10C is a perspective schematic view of the exemplary tool depicted in FIG. 10B, from a front side, with additional elements removed to show elements of the mechanical system.

FIG. 11A is an isolated perspective schematic side view of the exemplary tool depicted in FIG. 7, showing a mechanism for varying angle of attack.

FIG. 11B is an enlarged perspective schematic side view of the exemplary tool depicted in FIG. 11A, with a portion of cutaway, to show an exemplary mechanism for varying angle of attack.

FIG. 11C is a schematic side view of the mechanism for varying angle of attack of FIG. 11B, showing a first angle of attack.

FIG. 11D is a schematic side view of the mechanism for varying angle of attack of FIG. 11C, showing a second angle of attack.

FIG. 12A is a schematic illustration of a 2D design in which line features are used to provide notch angle information, depicting an embodiment in which each dash format represents a different notch angle.

FIG. 12B is a schematic illustration of a 2D design in which line features are used to provide notch angle information, depicting an embodiment in which each line thickness represents a different notch angle.

FIG. 12C is a schematic illustration of a 2D design in which line features are used to provide notch angle information, depicting an embodiment in which each line color represents a different notch angle.

FIG. 12D is a schematic illustration of a 3D design in which cut shape information provides notch angle information, including an embodiment in which the color of a cut surface maps to notch angle.

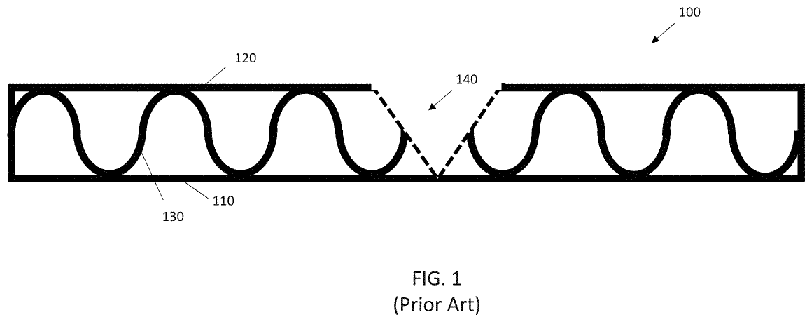

### DETAILED DESCRIPTION OF THE INVENTION

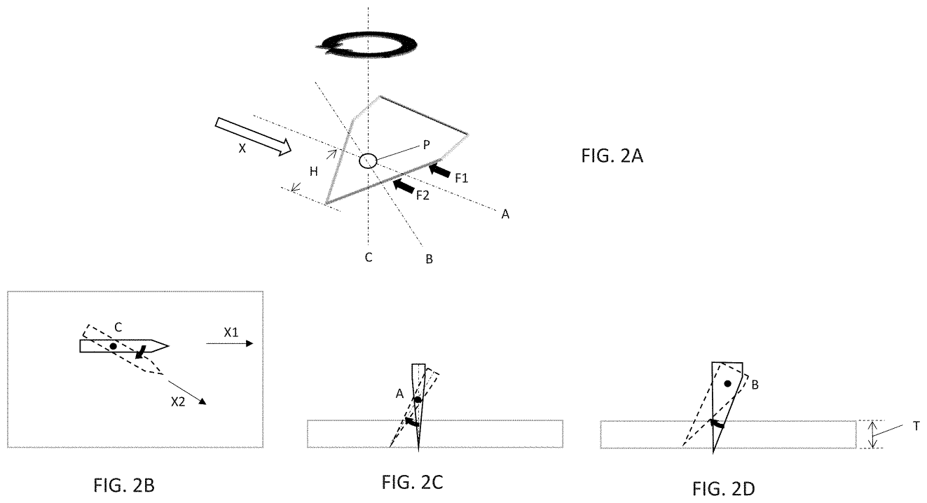

FIG. 2A-D schematically depict an exemplary knife tool configured to vary the angle of the knife blade around axes A, B and C. Rotation about axis C, which is perpendicular to the material being processed, gives the lateral cut direction. Thus, as shown in the top view of FIG. 2B, as the system moves the knife in a first path in the direction of arrow X1 that changes to the direction of arrow X2, the knife rotates about axis C so that the point of the knife blade is oriented pointing in the direction of travel. Axis A lies parallel to the horizontal/lateral movement vector of the tool, giving a knife inclination, referred to herein as the “notch angle.” Axis B lies perpendicular to the plane defined by the knife blade, giving an angle between the knife edge and the material being cut, referred to herein as the “angle of attack” or “attack angle.”

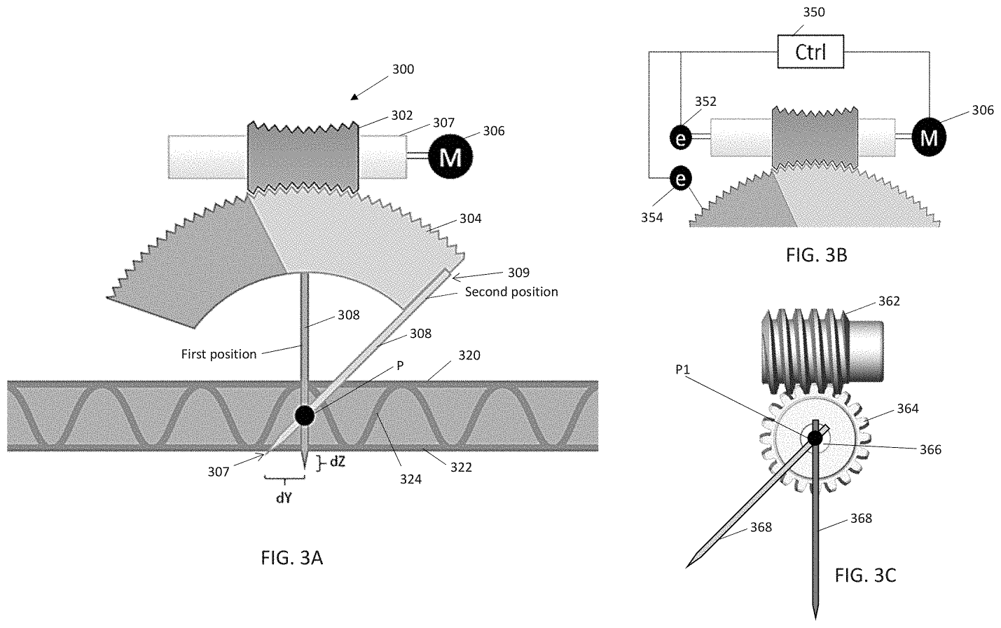

In exemplary embodiments, the knife blade is preferably configured to rotate to any angular position around axis C, to enable maximum flexibility in the cut direction. The system is preferably configured to permit infinite variability of the notch angle of the knife blade in a range around axis A, e.g. +/−60°, including in a 0° (vertical) angle, thus making the knife blade suitable for both angled and perpendicular/straight line cutting. The pivot point P (at which at least axes A and B intersect) is preferably a specified distance H from the distal tip of the knife blade, typically half the thickness T of the material being processed. Such a configuration balances the reaction forces F1, F2 that the material exerts on the knife blade around the C axis, so that the moment of the reaction force is preferably zero, which improves the quality/straightness of the cut. Axis C may also coincide with the pivot point, or may be located in another location on the plane of the knife blade. Control systems for controlling the notch angle, as described further herein, may be configured to permit selection of the knife angle pivot point at a desired distance from the substrate top surface as a non-changing reference point for kinematics relating to the knife. In preferred embodiments, the pivot point may be selectable within a range including at least a first point residing on the top surface of the substrate and at least a second point residing on the bottom surface of the substrate such that a cut line in the substrate relative to the pivot point is independent of the knife notch angle. Such a location for P is depicted in FIG. 3A.

Referring now to FIGS. 3A and 3B, a first exemplary mechanism for adjusting the notch angle of the blade is shown. In this embodiment, a partial worm gear drive 300 comprises a worm driver 302 intermeshed with a partial worm wheel 304 comprising to which knife blade holder 308 is mounted. The self-locking properties of this gear mechanism minimize the potential for forces exerted by the cutting of the material on the knife blade for causing an unintentional change of the notch angle of the blade. The positions of the worm driver and worm wheel can be detected using encoders 352, 354, respectively, connected to and configured to provide feedback to a controller 350. The encoders may be absolute or relative encoders, and may comprise optical, magnetic, inductive, or capacitive position sensors. Motor 306 coupled to a shaft 307 on which the worm driver gear 302 is mounted, may drive shaft 307 directly or via a gearbox/reducer, belt or other transmission mechanism. A predetermined rotation of the worm driver provides a corresponding adjustment of the notch angle. When the angle of the blade is adjusted, the distal end (tip) 307 of the blade is offset in two directions—dZ (vertical) and dY (lateral)—which offsets are calculated and compensated for in the control system by changing the position of the knife assembly relative to the substrate accordingly. Thus, the knife assembly is also preferably adjustable in the Z direction perpendicular to the substrate, as described further herein. As depicted, knife shaft 308 is shown in a first position with a zero notch angle and a second position with a non-zero notch angle. Knife shaft 308 has a proximal portion 309 attached to the partial worm wheel. The worm driver and partial worm wheel may be in a housing, such as depicted and described further herein.

Preferably, the range of notch angles achievable by the system includes a symmetrical range (e.g. −60 to +60 degrees relative to the first position). Accordingly, the circumferential portion of the worm wheel depicted in FIG. 3A is only a schematic representation and is not intended to depict the entire partial worm wheel or a representative spacing between the substrate and the partial worm wheel. In a preferred arrangement, the knife shaft is mounted in a center of the partial worm wheel, and the worm wheel is dimensioned and spaced from the substrate at a distance that permits the full 120 degree range of motion required to move the wheel from −60 to +60 degrees without the opposite ends of the wheel making contact with the substrate.

Although depicted as an enveloping (or double enveloping) worm driver 302 and partial worm wheel 304 in FIGS. 3A and 3B, the invention is not limited to any particular implementation. For example, as depicted in FIG. 3C, in an alternative embodiment, the worm-driver mechanism may comprise a non-enveloping worm driver 362 and the worm wheel may comprise a full 360-degree gear 364, with the knife shaft 368 connected to wheel 364 at pivot point P1 aligned with the axis of rotation of the wheel. Notably, in this embodiment pivot point P1 is located well above the material surface. While this location for the pivot point increases the forces on the knife blade relative to the embodiments with the pivot point located relatively lower as depicted in FIGS. 3A and 3B, and does not provide a static pivot point that can serve as a non-changing reference point for kinematics relating to the knife, this arrangement has an advantage of permitting standard bearings to be used for the worm wheel.

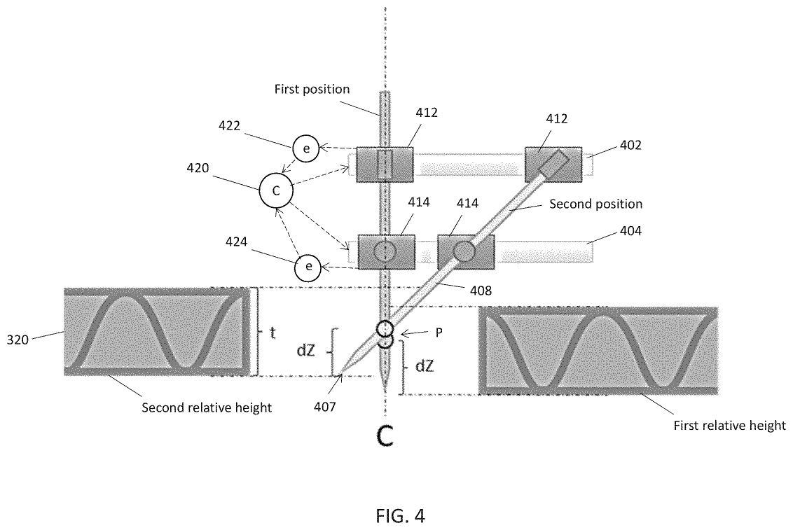

Referring now to FIG. 4, another exemplary mechanism 400 is depicted for adjusting the rotational pivot point P of an exemplary knife blade, which also minimizes impacts of the moment created by unequal reaction forces when cutting material. Mechanism 400 comprises two parallel linear guide elements 402, 404 on which respective carriages 412, 414 connected to the knife shaft 408. The respective linear positions of carriages 412, 414 are coordinated to change the angle of the blade to provide adjustability of the notch angle while also vertically translating the pivot point P of the blade to coincide with the rotation axis C. Carriage 412 connects to a first relatively proximal connection point on the knife shaft, whereas carriage 414 connects to a second intermediate connection point, located between the first connection point and the distal end 407 of the knife blade.

As depicted, knife shaft 408 is shown in a first position with a zero notch angle and a second position with a non-zero notch angle. Likewise, the substrate to be cut is shown at a first relative height corresponding to the first position of the knife shaft, and a second relative height corresponding to the second position of the knife shaft, for cuts having a desired depth in the thickness t of the substrate 450. The carriages may be driven by any type of actuator known in the art (e.g. a linear motor, a ball screw device operated by a motor (not shown), or a piezoelectric device). Motorized actuators may include two motors (one per linear guide element) or a single motor and a specific gearing between the two actuators. The actuators may be controlled by a controller 420 based upon feedback from encoders 422, 424 regarding the position of each carriage 412, 414.

FIG. 4 is intended to provide only a schematic view of the mechanism. Preferably, the range of notch angles achievable by the system includes a symmetrical range (e.g. −60 to +60 degrees relative to the first position). Accordingly, the linear guide elements preferably extend symmetrically on the left side and right side of the first position to provide a full range of motion.

In one embodiment, the knife angle of attack (i.e. rotation around axis B) may be implemented with an actuator mechanism configured to rotate the knife holder infinitely within a desired range, or by providing features in the knife holder that enable manual adjustment/mounting of the knife blade in one of a set of possible discrete positions.

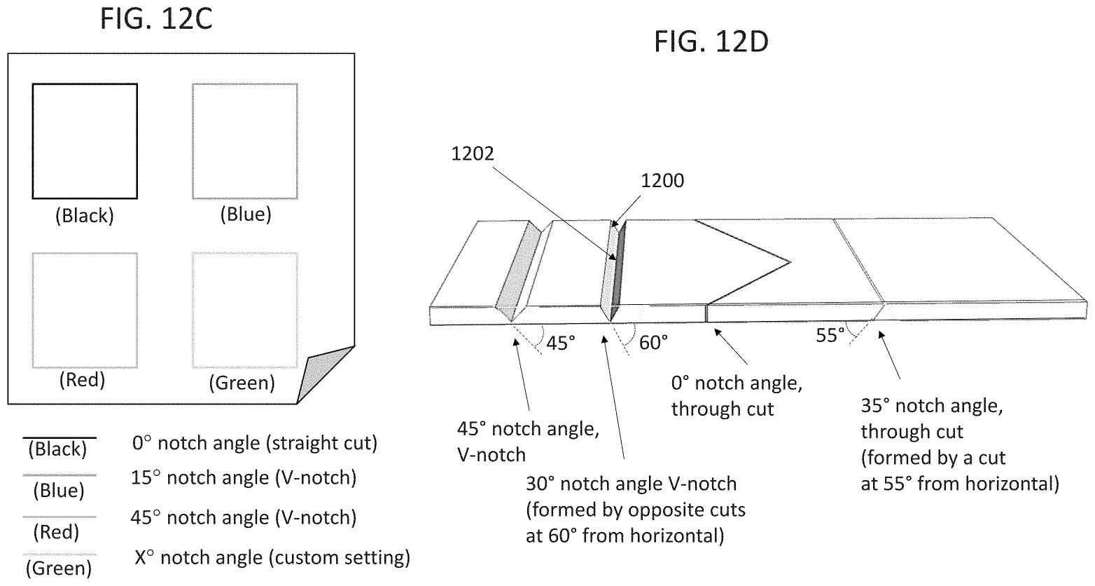

In preferred embodiments, the desired angles for the knife mechanism may be defined using information embedded within a design file. In exemplary embodiments depicted in FIGS. 12A-C, the angles may be represented using any line property of a 2D design file, including without limitation line type (e.g. dash type, representing notch angle, as depicted in FIG. 12A), line thickness (e.g. representing attack angle, as depicted in FIG. 12B), line color (e.g. representing notch angle, as depicted in FIG. 12C), where each line property is associated with the given angle. The foregoing are only examples and not intended to be limiting in any way. Commonly used angles may have preset information descriptors, whereas another line property (e.g. dotted dash format in FIG. 12A, green line color in FIG. 12C) may be used for custom angles, in which the desired angle is set in a dialogue with the operator of the tool or in a user-defined table.

The desired angle may also be derived from information embedded in a 3D CAD design file, where the 3D shape is translated into desired cut direction and notch angle, such as is depicted in FIG. 12D. The angle of attack may be associated with a cut surface property, such as without limitation, a cut surface color (e.g. a Pantone® number) as depicted in FIG. 12D, as mapped to a desired attack angle by the user in a job setup dialogue. Thus, for example, the color of surface 1200 may represent a first attack angle, whereas the color of surface 1202 may represent a second attack angle. As noted in claim 12D, notch angle nomenclature typically refers to the angle from vertical for one half of the notch. So, for example, a 45 degree notch angle, formed by opposite cuts angled at 45 degrees (from horizontal or vertical) results in a notch having an internal angle of 90 degrees. A 30 degree notch angle, formed by opposite cuts at 30 degrees from vertical (60 degrees from horizontal), results in a notch having an internal angle of 60 degrees. A “through cut” is a cut completely penetrates the thickness of the substrate being cut, where as a V-notch penetrates less than the full thickness. Notch angle settings and mechanisms as described herein may be used for creating through cuts or V-notches, without limitation.

Applications for the disclosed system include utilization for high speed through-cutting perpendicular to material surface or angled relative to perpendicular, such as for separating product from waste. Angled cuts may be used for design/aesthetic purposes, e.g. a “passe-partout.” The automatic tool may also be utilized for making folds, such as by making two angled partial (i.e. not fully penetrating the material) cuts facing towards each other (creating a V-trace in the material) facilitates folding of thicker paper and plastic based materials. An advantage of the disclosed device as compared to prior art devices, is that the same automatic tool is suitable for all the above stated applications, without the need for any operator intervention.

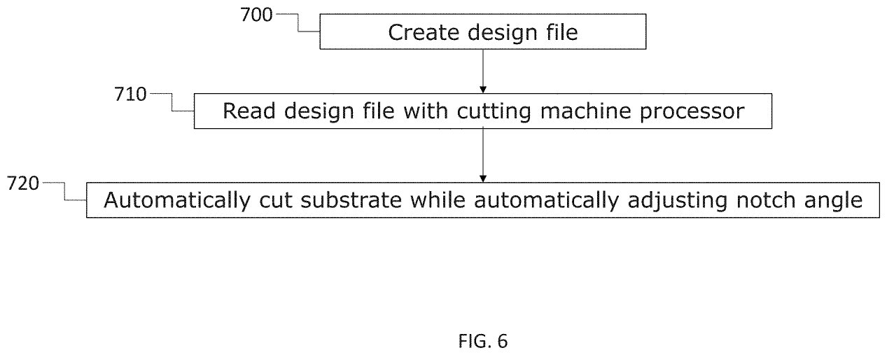

An exemplary method for cutting a substrate may include the following application workflow, as depicted in FIG. 6. In step 700, a design file is created in 2D or 3D, which contains information about each line that is to be cut, including what tool is to be used on each line (knife blade for cutting, creasing wheel for creating a crease, etc.) and for cuts, the relevant knife angles at which each line is to be cut with the automatic tool. In step 710, the design file is then read by a processor connected to the controller of the cutting machine, the processor programmed with software comprising instructions for interpreting and translating the design file information into a language readable by the controller, including translating the geometry of the cuts into tooling coordinates. Lines converted with different tools and/or different angles with the automatic tool may be represented in separate converting layers in the design files. Based on pre-defined settings and the design file information, the machine software can automatically assign each layer with a corresponding tooling configuration. In step 720, the machine operator starts the production, causing the machine to automatically select between the mounted tooling to convert the assigned layers and automatically adjust the angles of the automatic tool for converting the different knife-cut layers.

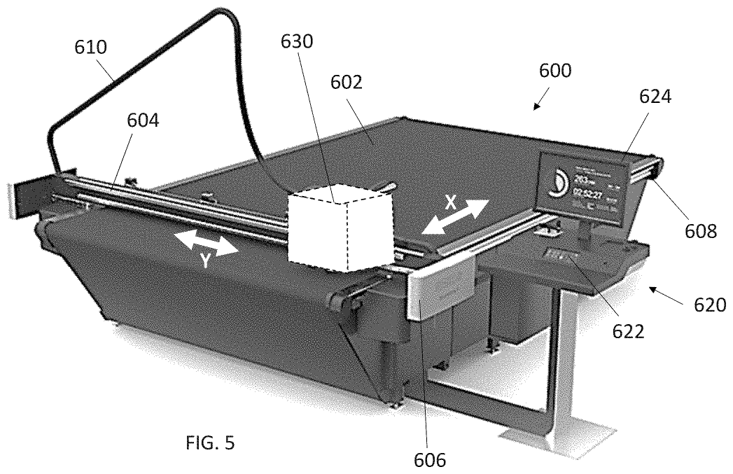

Referring now to FIG. 5, there is shown an exemplary cutting system 600. System 600 includes a base 602 for receiving a substrate to be cut, and a gantry 604 configured to traverse along rails 608 in the X direction, and a cutting tool 630 (schematically represented as a cube in FIG. 5, but detailed herein further in other drawings) on a carriage or wagon configured to traverse the gantry in the Y direction. The system for providing the relative motion between the substrate and the cutting tool may include any configuration known in the art, and is not limited to the configuration depicted in the figures. An exemplary control system 620 may include an integral computer processor and computer memory, a user interface 622, and a display 624. The computer processor is configured to read information embedded in a design file that resides in the computer memory and to translate the embedded information into commands for operation of the cutting system. The control system may include one or more positioners 606 for moving the gantry along rails 608 to a desired position along the X axis, one or more positioners embedded in cutting tool 630 for moving the carriage on which the cutting tool is mounted to a desired position on the gantry, Y-axis. Exemplary mechanisms for controlling the X-Y motion of a gantry and cutting tool carriage are well known in the art and are not further detailed herein. The control system further includes controllers and encoders for controlling the knife angles, as described herein with reference to the mechanisms depicted in FIG. 3B or FIG. 4. The cutting tool may be connected to the control system wirelessly or wired with a physical connection, such as flexible conduit 610, which may also be connected to a power source (not shown) for powering all of the automatic functions of the cutting tool as described herein.

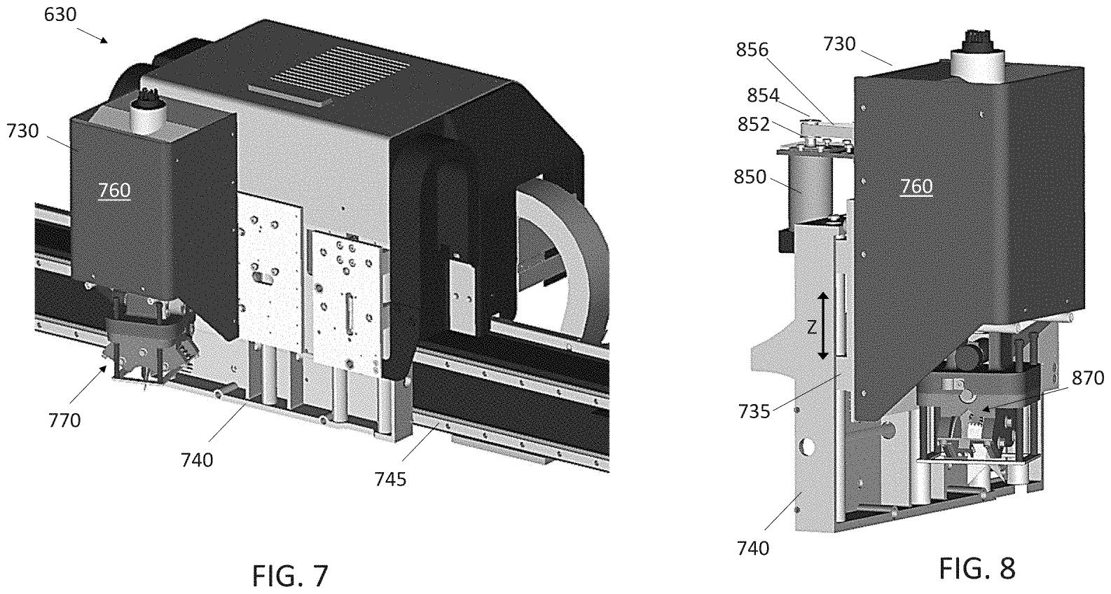

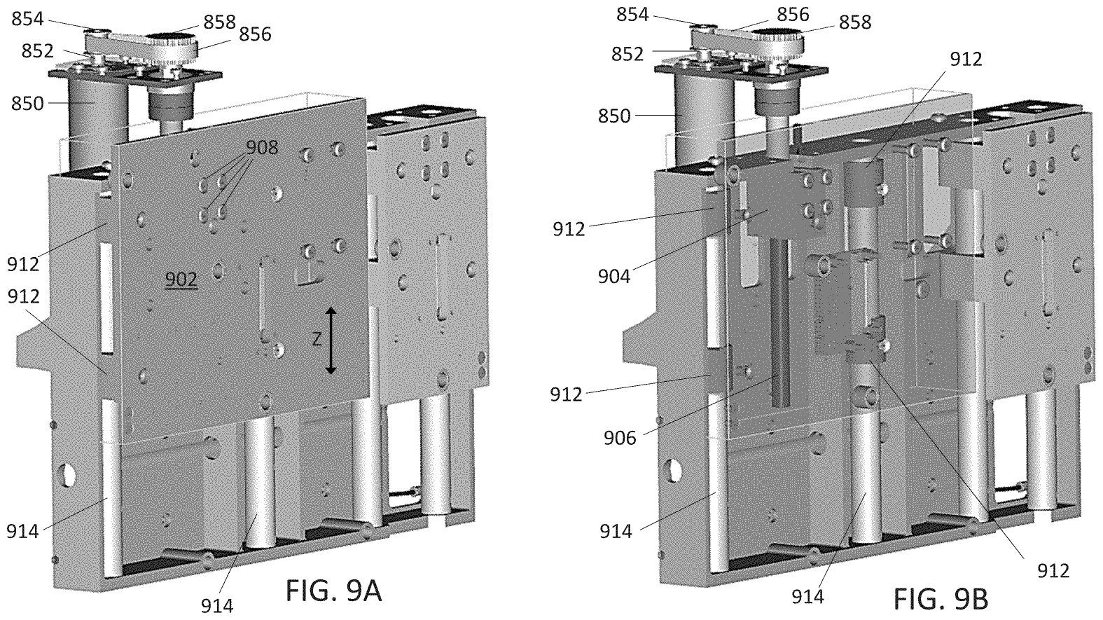

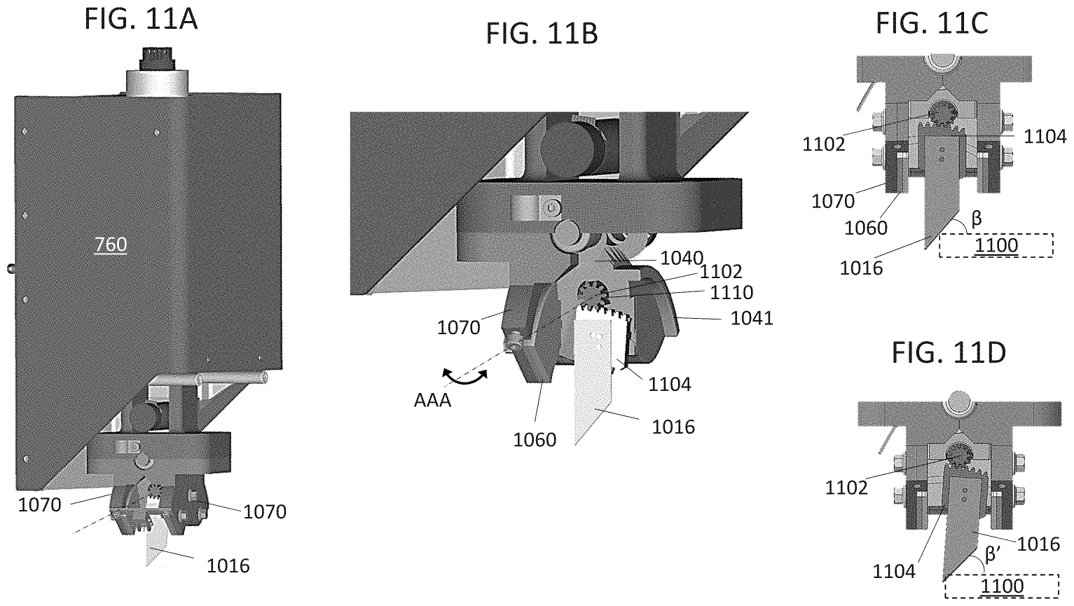

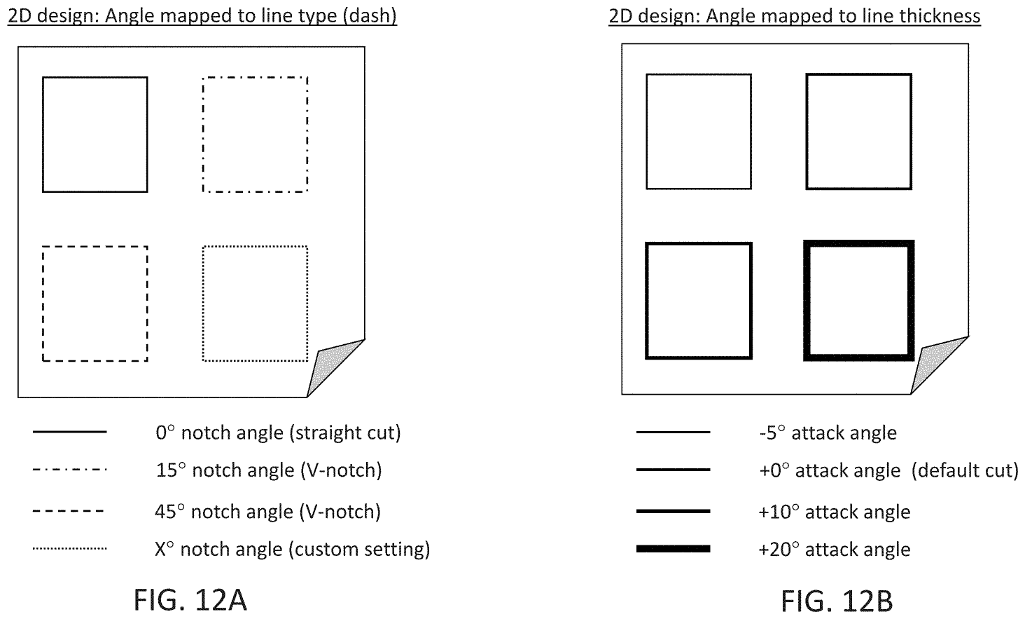

FIGS. 7 and 8 depict an exemplary tooling system 630 in more detail. Cutting tool 730 is mounted on Z-wagon 735 that is configured to traverse in the Z direction and mounted to a carriage 740 configured to traverse rails 745 in the Y direction. Motor 850 turns a shaft 852 on which is mounted a pulley 854 configured to drive a timing belt 856. Housing 760 covers various internal components, which will be discussed in more detail later herein. As depicted in FIGS. 7 and 8, the mechanism 770 for adjusting the notch angle of the blade is similar in structure to that depicted in FIGS. 3A and 3B, as discussed in more detail with reference to FIGS. 10A-10C. A mechanism 870 for adjusting the attack angle, discussed in more detail with reference to FIGS. 11A-11D is depicted in FIG. 8. Z-wagon 735 is configured to traverse along the Z direction, as depicted by the corresponding arrow.

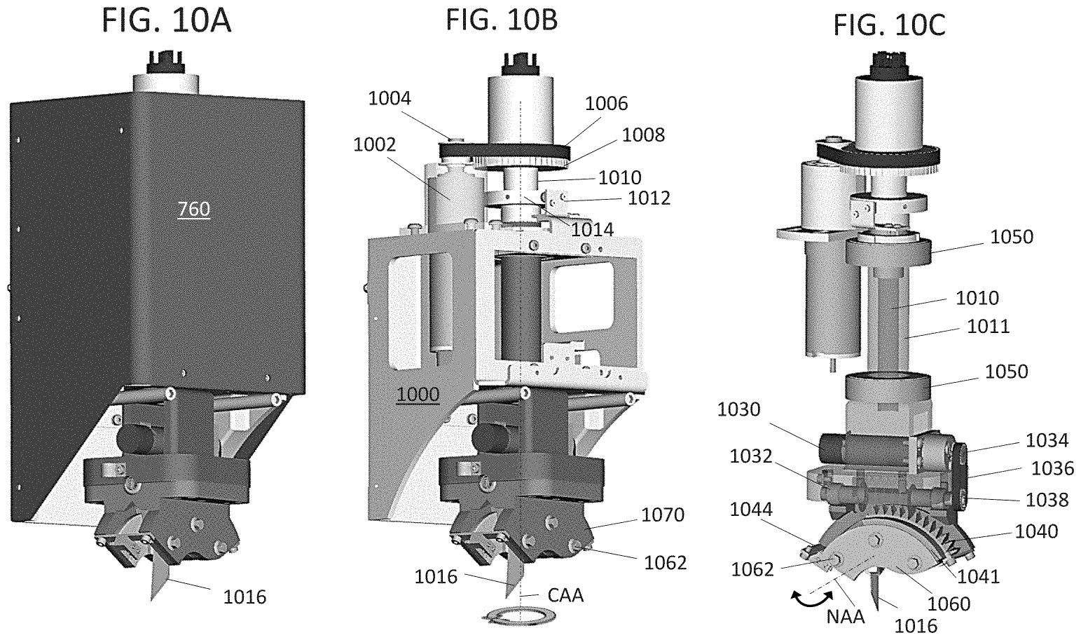

FIGS. 9A and 9B depict additional parts of the mechanism for driving Z-wagon 735. Z-wagon mounting plate 902 is attached to traveler 904, which may comprise a roller screw assembly by which the movement of timing belt 856 rotates timing gear 858 connected to roller screw shaft 906. Male threads (not shown) on roller screw shaft 906 mesh with female threads inside traveler 904 that converts rotation of the roller screw shaft into movement of the traveler in the Z direction. Plate 902 is fastened to traveler 904, such as with bolts 908. Plate 902 also has rear guides 912 that ride on guide rails 914 to maintain the proper orientation of plate 902 and to provide for smooth movement. The invention is not limited to any particular mechanism for providing Z-wagon movement; accordingly, the mechanism as depicted herein is only one possible example.

FIGS. 10A-10C depict in more detail exemplary mechanisms for adjusting the cut angle and the notch angle. Housing 760 mounts to frame 1000. To frame are mounted the mechanisms for adjusting the cut angle rotation, as depicted in more detail in FIG. 10B. The mechanism for adjusting the cut angle rotation includes a motor 1002 that turns a shaft on which is mounted pulley 1004, which turns timing belt 1006 connected to timing gear 1008, which turns cut angle shaft 1010. A sensor 1012, such as a hall sensor for sending position of collar 1014 relative to the sensor, which calibrates the positioning system by detecting the neutral orientation of the tool past the hall sensor each time the machine is started. As depicted in FIG. 10C, bearings 1050, such as ball bearings, support cut angle shaft 1010 and interface with bearing mounts on frame 1000. Shaft 1010 may be covered by an enclosure 1011. Thus, the foregoing exemplary mechanism may be used for positioning blade 1016 in any cut angle orientation along the cut angle axis (CAA) of rotation, although the mechanism is not limited to any particular embodiment.

As shown in more detail in FIG. 10C, the notch angle mechanism may comprise motor 1030 connected to worm driver 1032 via pulley 1034, timing belt 1036, and timing gear 1038. The flights of worm driver 1032 intermesh with the teeth of worm wheel 1040, such that rotation of worm driver positions worm wheel and permits blade 1016 to move along the notch angle axis (NAA) of rotation. End stop sensors 1044 may be provided on opposite sides of the worm wheel to prevent the wheel from over-extending in either direction. Worm wheel 1040 may comprise a geometry including semicircular rails 1041 on opposite sides of the gear, which run along a track defined by semicircular inserts 1060 held in place by worm wheel housing plates 1070 on opposite sides, affixed by bolts 1062. Thus, the foregoing exemplary mechanism may be used for positioning blade 1016 in any notch angle orientation along the axis of rotation NAA, although the mechanism is not limited to any particular embodiment. In embodiments, such as depicted in FIG. 3C, in which a full worm wheel is provided, a standard ball bearing (not shown) may be provided between housing plates 1070 (or attached to only a single housing plate) to receive shaft 366 on which the worm wheel 364 is mounted.

An exemplary angle of attack adjustment mechanism is shown in more detail in FIGS. 11A-11D. As best depicted in FIG. 11B, worm wheel 1040 may have a central bore 1110 (which may be formed by mating semi-cylindrical grooves in a two-piece construction) in which motor (not shown) is mounted to drive a pinion 1102 that drives an angle of attack rack 1104 to which blade 1060 is connected. Thus, the motion pinion 1102 and rack 1104 sets the angle of attack along the angle of attack axis (AAA) of rotation. Positioning of the pinion and rack in a first position as shown in FIG. 11C may provide for a neutral angle of attack in which the angled blade edge meets substrate 1100 to be cut at the blade edge angle β relative to horizontal. Positioning of the pinion and rack in a second position as shown in FIG. 11D may provide for an angle of attack that forms an angle β′ between the angled blade edge and the surface of the substrate that is more acute than angle β. The neutral position may be selected so that the angle of attack may be varied between a more acute angle and a less acute angle. Although depicted with a particular blade angle, the blade angle is not limited to any particular angle. Although depicted with a rack and pinion mechanism, the mechanism for modifying the angle of attack is not limited to any particular mechanism. Other mechanisms may include, for example, a piezoelectric linear actuator, which may use less space than a rack and pinion embodiment. Other embodiments may have an angle of attack that is not adjustable, or that is only manually adjustable. While shown as an infinitely adjustable angle of attack within the range of angles embodied in the rack and pinion, the angle may be adjustable among only a more limited set of discrete angles, such as by manually replacing a first blade having a first edge angle with a blade having a second edge angle.

Although exemplary systems are described herein for providing an automatically adjustable notch angle, the invention is not limited to the mechanisms shown, and may be implemented using any combination of elements known in the art for creating the functionality as described herein.

Aspects of the invention include features that provide several benefits including:
permitting cutting of arbitrary angles between 00 and 600 (e.g. 36° cut angle to create a 72° notch for a pentagon shaped box, allowing more creative freedom for the designer;
automatically adjusting the angle based on the job setup, allowing more productivity for the operator; and
replacing an oscillating knife for straight line cuts at 0°, further increasing productivity because of ability to cut at significantly higher speeds.
   Although the invention is illustrated and described herein with reference to specific embodiments, the invention is not intended to be limited to the details shown. Rather, various modifications may be made in the details within the scope and range of equivalents of the claims and without departing from the invention.

1-33. (canceled)

34. A knife assembly for cutting a substrate during relative motion between the knife and the substrate, the assembly comprising:
a knife having a distal knife blade and a proximal knife shaft attached to a holder, the holder rotatable about a first axis perpendicular to the substrate to define a cut direction angle, the holder configured to rotate the knife blade about a second axis perpendicular to the first axis to form a notch angle relative to the first axis, wherein the notch angle is infinitely adjustable within a range of angles.

35. The knife assembly of claim 34, wherein the holder is further configured to rotate the knife blade about a third axis perpendicular to a plane defined by the knife blade, wherein rotation about the third axis adjusts an angle of attack of the knife blade relative to the substrate within a desired range.

36. The knife assembly of claim 34, wherein the notch angle range of angles is symmetrical relative to the first axis from −60 to +60 degrees.

37. The knife assembly of claim 34, wherein the holder includes a worm gear assembly comprising a worm driver attached to a motor and a circumferential portion of a worm wheel, wherein the proximal end of the knife shaft is attached to the circumferential portion so that a predetermined rotation of the worm driver provides a corresponding adjustment of the notch angle.

38. The knife assembly of claim 37, wherein the knife shaft is connected to a rack having teeth intermeshed with a pinion, wherein position of the pinion provides a corresponding angle of attack.

39. The knife assembly of claim 38, wherein the worm wheel has a hollow portion in which is mounted a pinion driver connected to the pinion.

40. The knife assembly of claim 34, wherein a first relatively proximal connection point on the knife shaft connects to a linearly moveable portion of a first linear actuator and a second intermediate connection point, located between the first connection point and the distal end on the knife shaft, connects to a linearly moveable portion of a second linear actuator, wherein the first and second linear actuators are coordinated to provide adjustability of the notch angle while maintaining a second vertically translatable rotation axis of the knife lying along the first axis.

41. The knife assembly of claim 40, wherein each of the first and second linear actuators comprise a linear motor, a ball screw device, or a piezoelectric device.

42. A cutting system comprising: the knife assembly of claim 34, means for causing relative motion between the knife assembly and the substrate, and a control system for controlling a direction of the relative motion, the cut direction angle, and the notch angle.

43. The cutting system of claim 42, further comprising a control system for controlling angle of attack.

44. The cutting system of claim 42, wherein the knife assembly is adjustable in a Z direction perpendicular to the substrate.

45. The cutting system of claim 44, wherein the substrate comprises a thickness between a bottom planar surface and a top surface, and the control system is programmable to position the distal end of the knife blade relative to a thickness of the substrate and to cause relative motion between the knife assembly and the substrate operable to fully penetrate or not fully penetrate the substrate and to create zero and non-zero notch angles, including executing multiple cutting operations at a non-zero notch angle to form a V-notch in the substrate that does not fully penetrate the substrate.

46. The cutting system of claim 45, wherein the second and third axes of rotation intersect at a knife angle pivot point, the control system configured to permit selection of the knife angle pivot point at a desired distance from the substrate top surface as a non-changing reference point for kinematics relating to the knife.

47. The cutting system of claim 46, wherein the pivot point is selectable within a range including at least a first point residing on the top surface of the substrate and at least a second point residing on the bottom surface of the substrate such that a cut line in the substrate relative to the reference point is independent of the knife notch angle.

48. The cutting system of claim 42, further comprising a computer processor connected to a computer memory, the computer processor configured to read a design file residing in the computer memory, wherein the computer processor is configured to cause the control system to control operation of the knife assembly based upon information in the design file.

49. The cutting system of claim 48, wherein the design file is a 2D design file, and the control system is configured to select the cut direction angle and the direction of relative motion of the knife assembly based upon a location of lines in a 2D design file, and select values for the one of: the notch angle, the angle of attack, or a combination thereof, based upon a line property in the 2D design file.

50. The cutting system of claim 49, wherein the line property is selected from the group consisting of line type, line color, and line width.

51. The cutting system of claim 49, wherein one or more 2D design file line properties are associated with custom defined angle values and other line properties are predefined for a plurality of commonly used values.

52. The cutting system of claim 51, wherein the plurality of commonly used values include values selected from the group consisting of 0°, 15°, 22.5°, 300 and 45°.

53. The cutting system of claim 48, wherein the design file is a 3D design file, wherein the cut direction angle, the direction of relative motion, and the notch angle are derived from a 3D cut shape as defined in the 3D design file, and the angle of attack is defined by a cut surface property as represented in the 3D design file.

54. A method for cutting a substrate, comprising the steps of:
(a) providing a cutting system having an adjustable knife assembly comprising a knife having a distal knife blade and a proximal knife shaft attached to a knife holder, the knife holder (i) rotatable about a first axis perpendicular to the substrate to define a cut direction angle, (ii) configured to rotate the knife blade about a second axis perpendicular to the first axis to form a notch angle relative to the first axis, wherein the notch angle is infinitely adjustable within a range of angles, (iii) adjustable in a Z direction perpendicular to the substrate, and (iv) optionally, configured to rotate the knife blade about a third axis perpendicular to a plane defined by the knife blade, wherein rotation about the third axis adjusts an angle of attack of the knife blade relative to the substrate within a desired range; and
(b) causing relative motion between the knife assembly and the substrate, including automatically controlling a direction of the relative motion, the cut direction angle, and the notch angle, wherein automatically controlling the notch angle comprises automatically changing the notch angle from a first notch angle to a second notch angle using the adjustable knife assembly.

55. The method of claim 54, wherein the cutting system includes a computer processor, the method further comprising the computer processor reading information from a design file and controlling operation of the knife assembly and relative motion between the knife assembly and the substrate based upon information in the design file.

56. The method of claim 55, wherein the design file is a 2D design file, the method comprising the computer processor selecting the cut direction angle and the direction of relative motion of the knife assembly based upon a location of lines in the 2D design file, and selecting values for the notch angle and the angle of attack based upon a line property in the 2D design file.

57. The method of claim 55, wherein the design file is a 3D design file, the method comprising the computer processor selecting the cut direction angle, the direction of relative motion, and the notch angle based upon a 3D cut shape as defined in the 3D design file and the angle of attack based upon a line property represented in the 3D design file.

58. A non-transitory computer-readable medium encoded with instructions embodied in a design file readable by a computer processor for controlling a control system of a cutting system, the cutting system having an adjustable knife assembly comprising a knife having a distal knife blade and a proximal knife shaft attached to a knife holder, the knife holder (i) rotatable about a first axis perpendicular to the substrate to define a cut direction angle, (ii) configured to rotate the knife blade about a second axis perpendicular to the first axis to form a notch angle relative to the first axis, wherein the notch angle is infinitely adjustable within a range of angles, (iii) adjustable in a Z direction perpendicular to the substrate, and (iv) optionally, configured to rotate the knife blade about a third axis perpendicular to a plane defined by the knife blade, wherein rotation about the third axis adjusts an angle of attack of the knife blade relative to the substrate within a desired range, the cutting system further comprising means for causing relative motion between the knife assembly and the substrate, including automatically controlling a direction of the relative motion, the cut direction angle, and the notch angle, the instructions comprising:
instructions for controlling operation of the knife assembly and relative motion between the knife assembly and the substrate based upon information in the design file, including instructions for causing the control system to automatically change the notch angle from a first notch angle to a second notch angle using the adjustable knife assembly.

59. The non-transitory computer-readable medium of claim 58, wherein the design file is a 2D design file comprising instructions corresponding to a plurality of lines, each line having one or more line properties, wherein at least one line property corresponds to a selected value for the notch angle, at least one line property corresponds to the angle of attack, or a combination thereof.

60. The non-transitory computer-readable medium of claim 59, wherein the line property is selected from the group consisting of line type, line color, and line width.

61. The non-transitory computer-readable medium of claim 59, wherein one or more line properties are associated with custom defined angle values and a plurality of other line properties are predefined for a plurality of commonly used values.

62. The non-transitory computer-readable medium of claim 61, wherein the plurality of commonly used values include values selected from the group consisting of 0°, 15°, 22.5°, 300 and 45°.

63. The non-transitory computer-readable medium of claim 58, wherein the design file is a 3D design file, wherein the cut direction angle, the direction of relative motion, and the notch angle are represented by a 3D cut shape as defined in the 3D design file, and the angle of attack is defined by a cut surface property as represented in the 3D design file.

64. A method for creating a design file for being processed by a cutting system, the method comprising creating a design file embodying instructions readable by a computer processor for controlling a control system of a cutting system, the cutting system having an adjustable knife assembly comprising a knife having a distal knife blade and a proximal knife shaft attached to a knife holder, the knife holder (i) rotatable about a first axis perpendicular to the substrate to define a cut direction angle, (ii) configured to rotate the knife blade about a second axis perpendicular to the first axis to form a notch angle relative to the first axis, wherein the notch angle is infinitely adjustable within a range of angles, (iii) adjustable in a Z direction perpendicular to the substrate, and (iv) optionally, configured to rotate the knife blade about a third axis perpendicular to a plane defined by the knife blade, wherein rotation about the third axis adjusts an angle of attack of the knife blade relative to the substrate within a desired range, the cutting system further comprising means for causing relative motion between the knife assembly and the substrate, including automatically controlling a direction of the relative motion, the cut direction angle, and the notch angle, the instructions comprising instructions for controlling operation of the knife assembly and relative motion between the knife assembly and the substrate based upon information in the design file, including instructions for causing the control system to automatically change the notch angle from a first notch angle to a second notch angle using the adjustable knife assembly.

65. The method of claim 64, comprising creating the design file as a 2D design file comprising instructions corresponding to a plurality of lines, each line having one or more line properties, wherein at least one line property corresponds to a selected value for the notch angle, at least one line property corresponds to the angle of attack, or a combination thereof.

66. The method of claim 64, comprising creating the design file as a 3D design file, wherein the cut direction angle, the direction of relative motion, and the notch angle are represented by a 3D cut shape as defined in the 3D design file, and the angle of attack is defined by a cut surface property as represented in the 3D design file.
